(19) United States
(12) Patent Application Publication
(10) Pub. No.: US 2022/0215312 A1
(43) Pub. Date: Jul. 7, 2022

(54) EQUIPMENT CONFIGURATION PLAN GENERATION DEVICE, EQUIPMENT CONFIGURATION PLAN GENERATION METHOD, AND NON-TRANSITORY COMPUTER READABLE MEDIUM

(71) Applicant: NEC Corporation, Tokyo (JP)

(72) Inventors: Kazuki Tanabe, Tokyo (JP); Kozo Satoda, Tokyo (JP); Takayuki Kuroda, Tokyo (JP); Yutaka Yakuwa, Tokyo (JP); Takuya Kuwahara, Tokyo (JP); Tatsuya Fukuda, Tokyo (JP); Takashi Maruyama, Tokyo (JP)

(73) Assignee: NEC Corporation, Tokyo (JP)

(21) Appl. No.: 17/562,340

(22) Filed: Dec. 27, 2021

(30) Foreign Application Priority Data
Jan. 5, 2021 (JP) 2021-000397

(51) Int. Cl. G06Q 10/06

(52) U.S. Cl. CPC G06Q 10/06313

(57) ABSTRACT

In an equipment configuration plan generation device, an input unit receives an input value (request condition) of an entry regarding a request related to facility construction of a store and an input value (constraint condition) of an entry regarding a constraint condition related to the store. A concretization unit concretizes devices to be installed in the store in a step-by-step manner according to an input value of each entry regarding the constraint condition, and thereby generates an equipment configuration plan containing specific devices and satisfying the request (request condition).

### INCORPORATION BY REFERENCE

This application is based upon and claims the benefit of priority from Japanese patent application No. 2021-000397, filed on Jan. 5, 2021, the disclosure of which is incorporated herein in its entirety by reference.

### TECHNICAL FIELD

The present disclosure relates to an equipment configuration plan generation device, an equipment configuration plan generation method, and a control program.

### BACKGROUND ART

A system that supports designing a store is proposed (for example, Japanese Unexamined Patent Application Publication No. 2003-296372). The store design support system disclosed in Japanese Unexamined Patent Application Publication No. 2003-296372 stores design information of virtual stores and design information of actual stores in the past in a database, and it receives search criteria and searches the database for design information that matches the search criteria.

However, since the technique disclosed in Japanese Unexamined Patent Application Publication No. 2003-296372 searches for completed design information of a store by using search criteria, it can fail to generate a flexible equipment configuration plan that satisfies the requests from a client (for example, a store owner etc.).

### SUMMARY

An object of the present disclosure is to provide an equipment configuration plan generation device, an equipment configuration plan generation method, and a control program capable of generating a flexible equipment configuration plan that satisfies the requests from a client.

An equipment configuration plan generation device according to a first aspect includes an input unit configured to receive input values of an entry regarding a request related to facility construction of a store and an entry regarding a constraint condition related to the store; a concretization unit configured to concretize devices to be installed in the store in a step-by-step manner according to an input value of each entry regarding the constraint condition, and thereby generates an equipment configuration plan containing specific devices and satisfying the request; and an output unit configured to output the generated equipment configuration plan.

An equipment configuration plan generation method according to a second aspect includes receiving input values of an entry regarding a request related to facility construction of a store and an entry regarding a constraint condition related to the store; and concretizing devices to be installed in the store in a step-by-step manner according to an input value of each entry regarding the constraint condition, and thereby generating an equipment configuration plan containing specific devices and satisfying the request.

A control program according to a third aspect causes an equipment configuration plan generation device to execute a process including receiving input values of an entry regarding a request related to facility construction of a store and an entry regarding a constraint condition related to the store; and concretizing devices to be installed in the store in a step-by-step manner according to an input value of each entry regarding the constraint condition, and thereby generating an equipment configuration plan containing specific devices and satisfying the request.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram showing an example of an equipment configuration plan generation device according to a first example embodiment;

FIG. 2 is a block diagram showing an example of an equipment configuration plan generation device according to a second example embodiment;

FIG. 3 is a view showing an example of an input data message according to the second example embodiment;

FIG. 4 is a view illustrating an example of processing by an input unit according to the second example embodiment;

FIG. 5A is a view showing an example of the data structure of a concretization pattern;

FIG. 5B is a view showing an example of the data structure of a concretization pattern;

FIG. 5C is a view showing an example of the data structure of a concretization pattern;

FIG. 6A is a view showing an example of the data structure of device data;

FIG. 6B is a view showing an example of the data structure of device data;

FIG. 6C is a view showing an example of the data structure of device data;

FIG. 7 is a flowchart showing an example of a processing operation of the equipment configuration plan generation device according to the second example embodiment;

FIG. 8 is a view illustrating an example of application of a concretization pattern according to the second example embodiment;

FIG. 9 is a view illustrating an example of application of a concretization pattern according to the second example embodiment;

FIG. 10 is a view illustrating an example of application of a concretization pattern according to the second example embodiment;

FIG. 11 is a view illustrating an example of application of a concretization pattern according to the second example embodiment;

FIG. 12 is a view illustrating request verification according to the second example embodiment; and

FIG. 13 is a view showing a hardware configuration example of an equipment configuration plan generation device.

### EMBODIMENTS

Example embodiments are described hereinafter with reference to the drawings. It should be noted that, in the example embodiments, the same or equivalent elements are denoted by the same reference symbols, and the redundant explanation thereof is omitted.

### First Example Embodiment

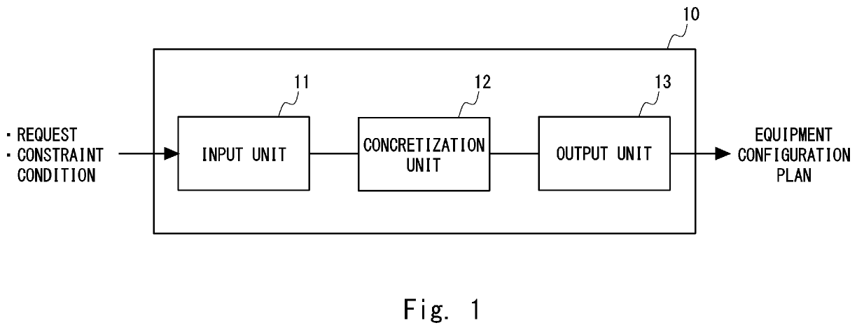

FIG. 1 is a block diagram showing an example of an equipment configuration plan generation device according to a first example embodiment. In FIG. 1, an equipment configuration plan generation device 10 includes an input unit 11, a concretization unit 12, and an output unit 13.

The input unit 11 receives an input value of an “entry regarding a request” (request condition) related to facility construction of a store and an input value of an “entry regarding a constraint condition” (constraint condition) related to the store. Those input values may be input by a user (an owner, a designer etc. who makes a request for store design) of the equipment configuration plan generation device 10 by using a terminal (not shown). The terminal (not shown) may be a mobile terminal or a stationary terminal. Further, those input values may be automatically input by an external system (not shown) or the like, for example. Note that “facility construction” includes not only new construction of a target facility but also various types of renovation (renewal) such as expansion and downsizing.

The “entry regarding a request” may be “budget”, “devices desired to be installed”, “the type and number of devices desired to be installed” and so on, for example. The “entry regarding a constraint condition” may be “store size”, “location (store opening area, estimated number of clients etc.)”, “allowable power in the store” and so on, for example.

The concretization unit 12 concretizes devices to be installed in a store in a step-by-step manner according to input values of entries regarding the constraint condition and thereby generates an “equipment configuration plan” that contains specific devices and satisfies the request (request condition).

The output unit 13 outputs the “equipment configuration plan” generated in the concretization unit 12. This output “equipment configuration plan” may be displayed on a display unit of the terminal (not shown).

As described above, according to the first example embodiment, in the equipment configuration plan generation device 10, the concretization unit 12 concretizes devices to be installed in a store in a step-by-step manner according to an input value of each entry regarding the constraint condition (constraint condition) and thereby generates the “equipment configuration plan” that contains specific devices and satisfies the request (request condition).

Since this configuration of the equipment configuration plan generation device 10 concretizes devices to be installed in a store in a step-by-step manner according to an input value of each entry regarding the constraint condition, rather than searching for completed design information with search criteria, it enables flexible generation of an equipment configuration plan. It also enables generation of an equipment configuration plan that satisfies the request (request condition).

### Second Example Embodiment

A second example embodiment relates to a more specific embodiment.

### <Configuration Example of Equipment Configuration Plan Generation Device>

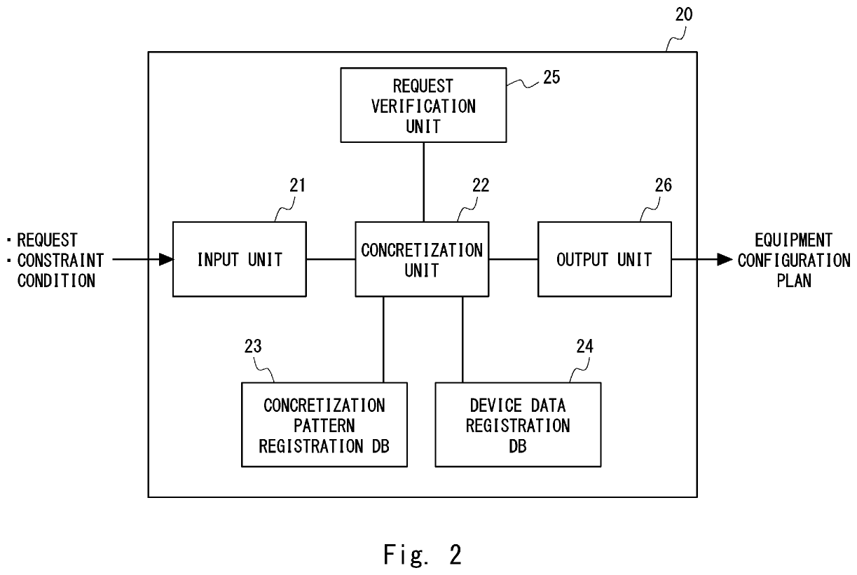

FIG. 2 is a block diagram showing an example of an equipment configuration plan generation device according to a second example embodiment. In FIG. 2, an equipment configuration plan generation device 20 includes an input unit 21, a concretization unit 22, a concretization pattern registration database (DB) 23, a device data registration database (DB) 24, a request verification unit 25, and an output unit 26.

The input unit 21 receives an input value of an “entry regarding a request” (request condition) related to facility construction of a store and an input value of an “entry regarding a constraint condition” (constraint condition) related to the store. The input value of the “entry regarding a request” (request condition) and the input value of the “entry regarding a constraint condition” (constraint condition) may be contained in an “input data message”, for example, and transmitted (output) from a terminal (not shown) to the equipment configuration plan generation device 20.

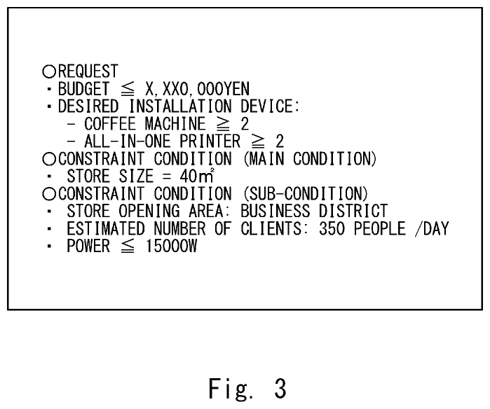

FIG. 3 is a view showing an example of an input data message according to the second example embodiment. The input data message shown in FIG. 3 contains a “request field” and a “constraint condition field”. The “request field” contains an input value (input condition) of the entry “budget” and an input value (input condition) of the entry “desired installation device”. For example, the input value of the entry “budget” is “budget≤xxx0000 yen”, and the input value of the entry “desired installation device” is “coffee machine≥2”, “all-in-one printer≥2”. “Coffee machine≥2” indicates that two or more coffee machines are desired to be installed, and “all-in-one printer≥2” indicates that two or more all-in-one printers are desired to be installed.

The “constraint condition field” contains an input value of the entry “store size”, an input value of the entry “store opening area”, an input value of the entry “estimated number of clients”, and an input value of the entry “allowable power”. For example, the input value of the entry “store size” is “40 m² (square meters)”, and the input value of the entry “store opening area” is “business district”. Further, the input value of the entry “estimated number of clients” is “350 people/day (350 people per day)”, and the input value of the entry “allowable power” is “power≤15000 W (watts)”.

Regarding the plurality of entries of “constraint condition”, all of them may be treated in the same way, or some of the entries may be treated as “main entries” and the rest of the entries may be treated as “sub-entries”. In the latter case, the constraint condition field may contain “constraint (main constraint) field” and “constraint (subconstraint) field”. Note that FIG. 3 is a view conceptually illustrating the data structure of the input data message, and data representing the respective entries are associated with one another so as to satisfy the relationship of the entries illustrated by an example in this figure.

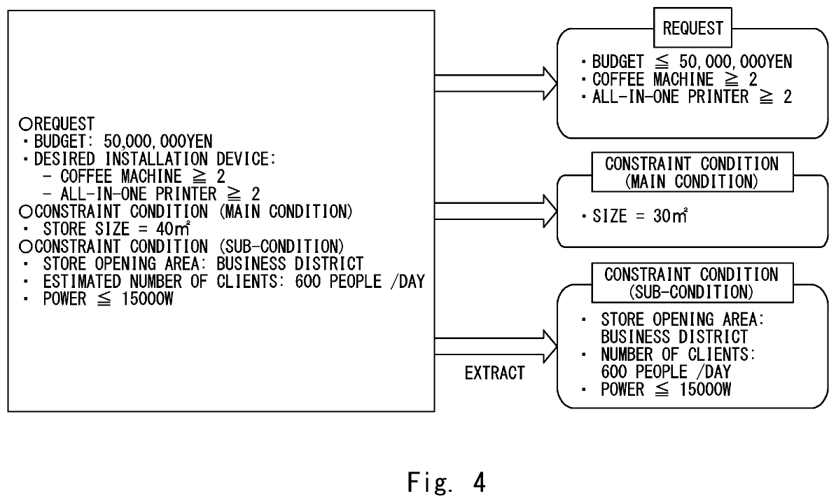

In the case where the input unit 21 receives the input data message shown in FIG. 3, the input unit 21 may extract the input value of “request field”, the input value of “constraint condition field”, the input value of “constraint condition (main condition) field”, and the input value of “constraint condition (sub-condition) field”. Then, the input unit 21 may pass the extracted input values to the concretization unit 22. FIG. 4 is a view illustrating an example of processing by the input unit according to the second example embodiment.

The concretization unit 22 concretizes devices to be installed in a store in a step-by-step manner on the basis of a “concretization pattern” corresponding to the input value of each entry of the “constraint condition” and thereby generates a “equipment configuration plan” that contains specific devices. As described later, the “concretization pattern” is registered in the concretization pattern registration DB 23, and the concretization unit 22 uses the “concretization pattern” registered in the concretization pattern registration DB 23.

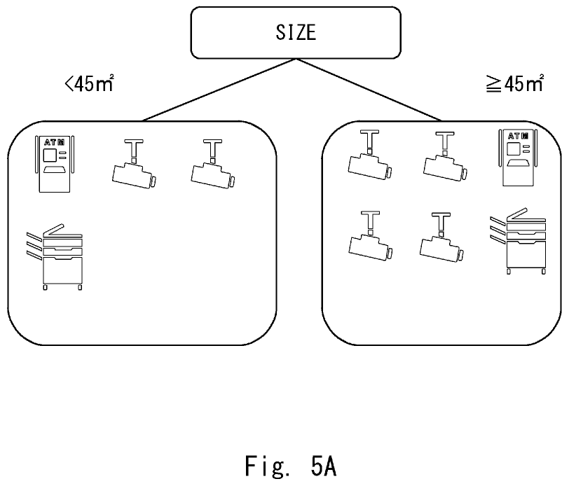

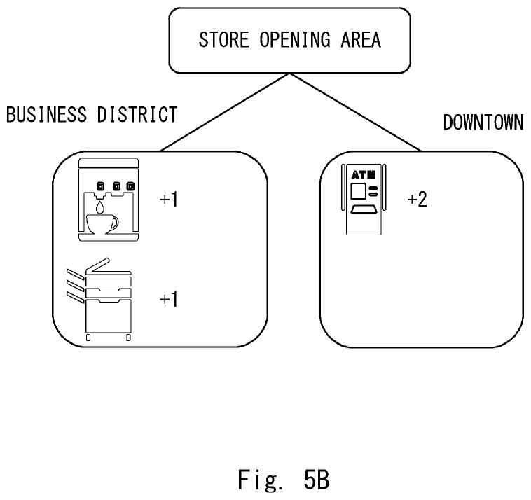

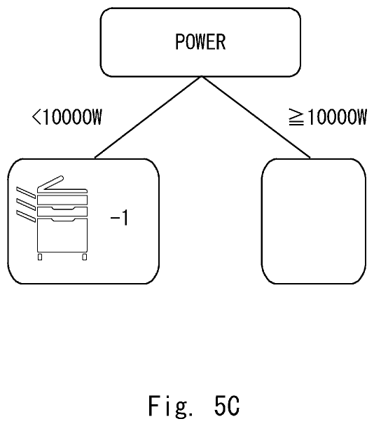

The concretization pattern registration DB 23 stores the “concretization pattern” corresponding to the entry of the constraint condition and the input value. FIGS. 5A, 5B, and 5C are views showing examples of the data structure of the concretization pattern. FIGS. 5A, 5B, and 5C are views conceptually illustrating the data structure of the concretization pattern, and in a database (memory, storage unit), data representing the respective entries are associated with one another so as to satisfy the relationship of the entries illustrated by an example in this figure.

FIG. 5A is a view showing an example of the concretization pattern corresponding to the entry “store size” of the constraint condition. FIG. 5A shows a “concretization pattern when the store size is smaller than 45 m²” and a “concretization pattern when the store size is equal to or greater than 45 m²”. In the example of FIG. 5A, the “concretization pattern when the store size is smaller than 45 m²” is a concretization pattern that generates a “candidate equipment configuration” that contains one ATM (automatic teller machine), one all-in-one printer, and two security cameras. The “concretization pattern when the store size is equal to or greater than 45 m²” is a concretization pattern that generates a “candidate equipment configuration” that contains one ATM, one all-in-one printer, and four security cameras.

FIG. 5B is a view showing an example of the concretization pattern corresponding to the entry “store opening area” of the constraint condition. FIG. 5B shows a “concretization pattern when the store opening area is a business district” and a “concretization pattern when the store opening area is downtown”. In the example of FIG. 5B, the “concretization pattern when the store opening area is a business district” is a concretization pattern that generates a “candidate equipment configuration” by adding one coffee machine and one all-in-one printer. The “concretization pattern when the store opening area is downtown” is a concretization pattern that generates a “candidate equipment configuration” by adding two ATMs.

FIG. 5C is a view showing an example of the concretization pattern corresponding to the entry “power” of the constraint condition. FIG. 5C shows a “concretization pattern when the allowable power is less than 10000 watts” and a “concretization pattern when the allowable power is equal to or more than 10000 watts”. In the example of FIG. 5C, the “concretization pattern when the allowable power is less than 10000 watts” is a concretization pattern that generates a “candidate equipment configuration” by eliminating one all-in-one printer. Further, the “concretization pattern when the allowable power is equal to or more than 10000 watts” is a concretization pattern that maintains the current “candidate equipment configuration”.

In the case where the “constraint condition” is sorted into a “main condition (main entries)” and a “sub-condition (sub-entry)” as described above, the concretization unit 22 creates a “sub-condition list” where each “sub-entry” and its input value (sub-condition) are associated with each other. It is assumed in this example that the “main condition (main entry)” is “store size”, and the “sub-condition (sub-entry)” is the “store opening area” and “power”.

Then, the concretization unit 22 first generates a “candidate base equipment configuration” by using the concretization pattern corresponding to the input value (main condition) of the “main entry”. For example, the concretization unit 22 generates the “candidate base equipment configuration” by using the concretization pattern (FIG. 5A) corresponding to the input value of the entry “store size”.

The concretization unit 22 then selects one from the plurality of “sub-conditions (sub-entries)” contained in the “sub-condition list”. Then, the concretization unit 22 applies the concretization pattern corresponding to the input value (sub-condition) of the selected “sub-entry” to the “candidate base equipment configuration”, and thereby generates a “candidate equipment configuration”. For example, when the “store opening area” is selected as the “sub-entry”, the concretization unit 22 applies the concretization pattern (FIG. 5B) corresponding to the input value of the entry “store opening area” to the “candidate base equipment configuration” and thereby generates the “candidate equipment configuration”.

The concretization unit 22 then calculates a “condition determination value” for the generated “candidate equipment configuration”. For example, the concretization unit 22 refers to device data stored in the device data registration DB 24 and calculates a “condition determination value (absolute condition determination value)” for the “main condition (main entry)” of the “candidate equipment configuration”. To be specific, the “absolute condition determination value” for the entry “store size” is calculated as the sum of the occupied areas of the respective devices contained in the “candidate equipment configuration”. Note that the concretization unit 22 may further calculate, as a “request condition determination value”, the sum of the amounts of money of the respective devices contained in the “candidate equipment configuration”. The data structure of device data stored in the device data registration DB 24 is described later.

When the calculated “absolute condition determination value” satisfies the main condition, the concretization unit 22 selects a “sub-condition (sub-entry)” that has not been selected from the “sub-condition list”. Then, the concretization unit 22 applies the concretization pattern corresponding to the input value of the selected “sub-entry” to the “candidate equipment configuration” to be processed, and thereby generates a “candidate equipment configuration”. The concretization unit 22 repeatedly generates the “candidate equipment configuration” until there is no more “sub-entry (sub-condition)” that has not been selected in the “sub-condition list”. Note that when the calculated “absolute condition determination value” does not satisfy the main condition, the “candidate equipment configuration” is changed back to the “candidate equipment configuration” before application of the concretization pattern, and a “sub-condition (sub-entry)” that has not been selected is selected from the “sub-condition list”.

When the calculated “absolute condition determination value” satisfies the main condition and there is no “sub-entry” that has not been selected in the “sub-condition list”, the concretization unit 22 gives the candidate equipment configuration and the request to the request verification unit 25, and thereby makes inquiries to the request verification unit 25 as to whether the candidate equipment configuration satisfies the request or not. For example, the concretization unit 22 may pass the generated “candidate equipment configuration”, the “input value of request (request condition)”, and the calculated “request condition determination value” to the request verification unit 25 and make inquiries as to whether the candidate equipment configuration satisfies the request or not.

When a determination result received from the request verification unit 25 indicates that the candidate equipment configuration satisfies the request, the concretization unit 22 outputs the candidate equipment configuration as an equipment configuration plan.

The request verification unit 25 determines whether the candidate equipment configuration satisfies the request or not, and outputs a determination result to the concretization unit 22. When the concretization unit 22 receives the determination result indicating that the request is satisfied, the concretization unit 22 passes the candidate equipment configuration to the output unit 26. The output unit 26 outputs the candidate equipment configuration received from the concretization unit 22 as the equipment configuration plan.

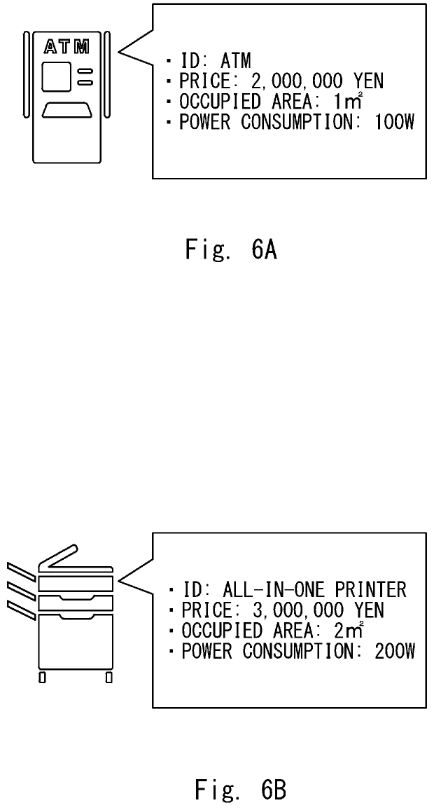

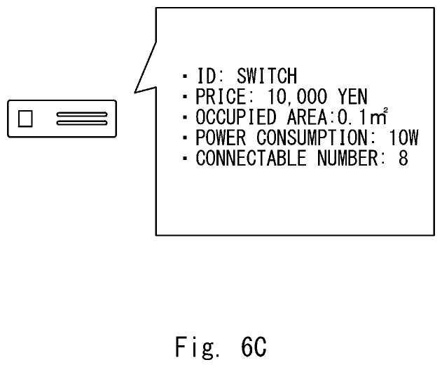

The device data registration DB 24 stores device data of each device. Each of FIGS. 6A, 6B, and 6C is a view showing an example of the data structure of device data. FIGS. 6A, 6B, and 6C are views conceptually illustrating the data structure of device data, and in a database (memory, storage unit), data representing the respective entries are associated with one another so as to satisfy the relationship of the entries illustrated by an example in this figure. FIG. 6A shows the data structure of device data of an ATM. In FIG. 6A, the device data of the ATM is such that the value of the entry “ID” is “ATM”, and the value of the entry “price” is “2,000,000 yen”. Further, the value of the entry “occupied area” is “1 m²”, and the value of the entry “power consumption” is “100 watts”. FIG. 6B shows the data structure of device data of an all-in-one printer. In FIG. 6B, the device data of the all-in-one printer is such that the value of the entry “ID” is “all-in-one printer”, and the value of the entry “price” is “3,000,000 yen”. Further, the value of the entry “occupied area” is “2 m²”, and the value of the entry “power consumption” is “200 watts”. FIG. 6C shows the data structure of device data of a switch. In FIG. 6C, the device data of the switch is such that the value of the entry “ID” is “switch”, and the value of the entry “price” is “10,000 yen”. Further, the value of the entry “occupied area” is “0.1 m²”, the value of the entry “power consumption” is “10 watts”, and the value of the entry “connectable number” is “8”.

The above-described “candidate base equipment configuration” contains the ID of each device contained in the “candidate base equipment configuration”. Likewise, the above-described “candidate equipment configuration” contains the ID of each device contained in the “candidate equipment configuration”. Thus, the concretization unit 22 can calculate the above-described “condition determination value” by referring to the device data registration DB 24 by using the device ID as a key.

### <Operation Example of Equipment Configuration Plan Generation Device>

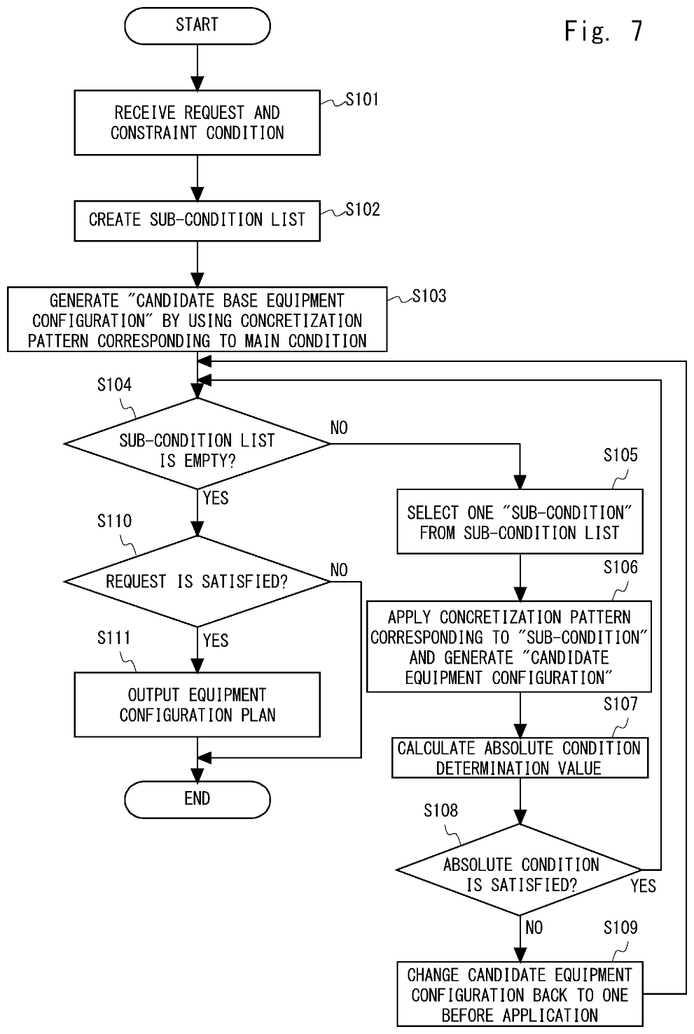

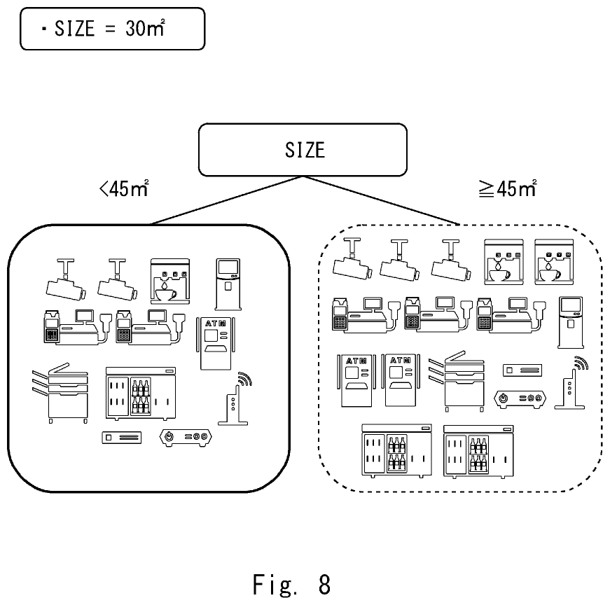

An example of the processing operation of the equipment configuration plan generation device having the above-described configuration is described hereinafter. FIG. 7 is a flowchart showing an example of the processing operation of the equipment configuration plan generation device according to the second example embodiment. FIGS. 8 to 11 are views illustrating examples of application of a concretization pattern according to the second example embodiment.

In the equipment configuration plan generation device 20, the input unit 21 receives an input value of an “entry regarding a request” (request condition) related to facility construction of a store and an input value of an “entry regarding a constraint condition” (constraint condition (main condition, sub-condition)) related to the store (Step S101).

The concretization unit 22 creates a “sub-condition list” (Step S102).

The concretization unit 22 generates a “candidate base equipment configuration” by using a concretization pattern corresponding to the “main condition” (Step S103). It is assumed in this example that the “main condition” is “store size=30 m²”. As shown in FIG. 8, the concretization unit 22 generates the “candidate base equipment configuration” by using the “concretization pattern when the store size is smaller than 45 m²”. Note that in FIGS. 8 to 11, each thick frame shows the concretization pattern used.

The concretization unit 22 determines whether the “sub-condition list” is empty or not, i.e., whether all sub-conditions contained in the “sub-condition list” are selected or not (Step S104).

When the “sub-condition list” is not empty (No in Step S104), the concretization unit 22 selects one sub-condition from the “sub-condition list” (Step S105). The selected sub-condition is removed from the “sub-condition list”. It is assumed in this example that “store opening area=business district” is selected as the sub-condition.

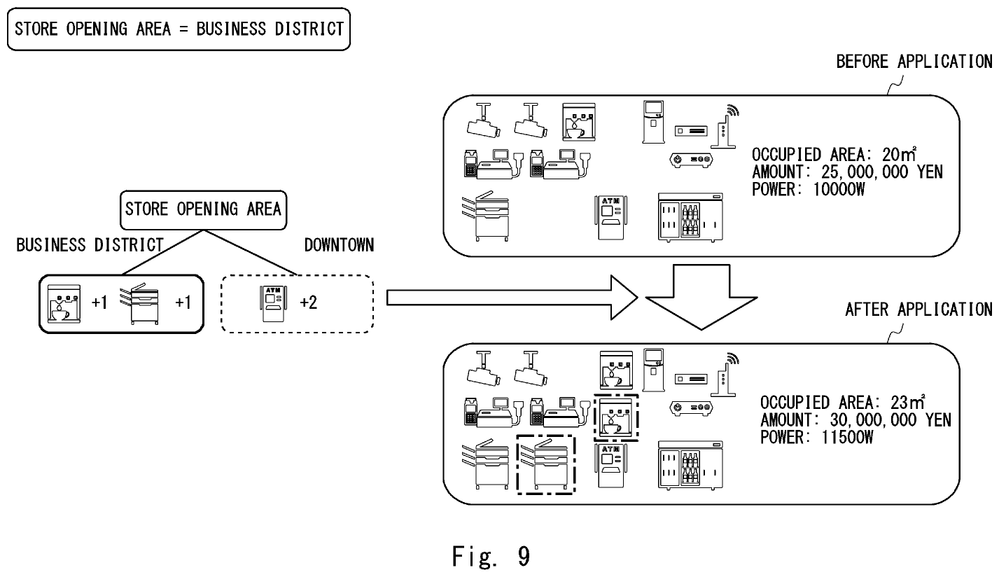

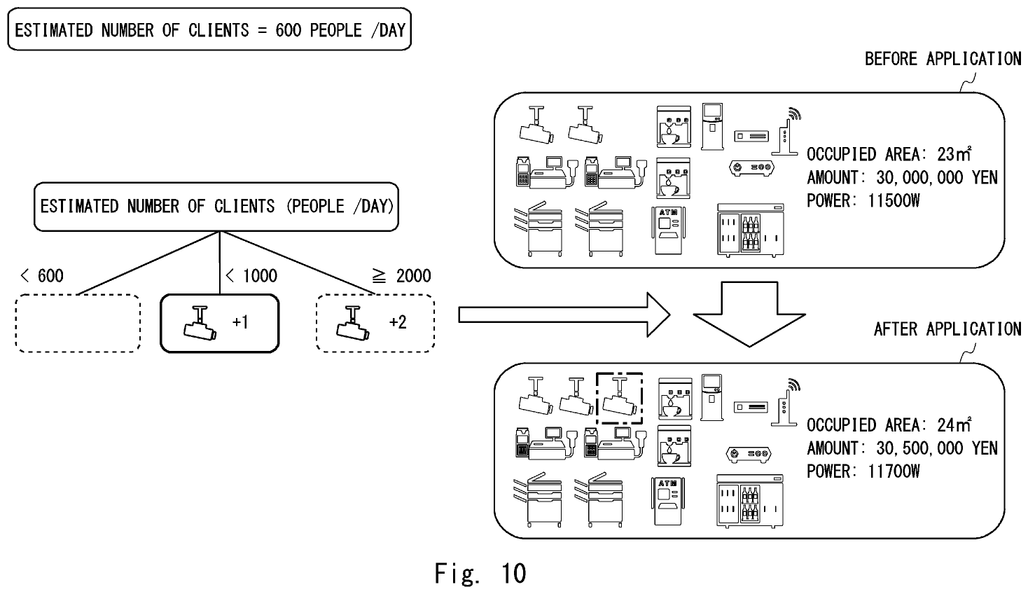

The concretization unit 22 applies the concretization pattern corresponding to the selected sub-condition to the candidate equipment configuration (which is the candidate base equipment configuration in this example) and thereby generates the candidate equipment configuration (Step S106). In this example, as shown in FIG. 9, the concretization unit 22 applies the “concretization pattern when the store opening area is a business district” to the candidate equipment configuration (which is the candidate base equipment configuration in this example). Specifically, in the example of FIG. 9, one coffee machine and one all-in-one printer are added to the candidate base equipment configuration.

The concretization unit 22 calculates the “absolute condition determination value” for the main condition (main entry) in the candidate equipment configuration generated in Step S106 (Step S107). To be specific, the concretization unit 22 calculates, as the “absolute condition determination value”, the sum of the occupied areas of the devices contained in the candidate equipment configuration generated in Step S106. In this example, as shown in FIG. 9, the calculated “absolute condition determination value” is “23 m²”. In Step S107, the concretization unit 22 may calculate the above-described “request condition determination value”.

The concretization unit 22 determines whether the calculated absolute condition determination value satisfies the absolute condition (which is “occupied area≤30 m²” in this example) or not (Step S108). Although the example in which the “absolute condition” includes the same numerical value as the “main condition” is shown here for easier explanation, the example embodiment is not limited thereto. For example, the “absolute condition” may include a numerical value obtained by multiplying the numerical value of the main condition by a factor that is greater than 0 and smaller than 1. For example, the concretization unit 22 may create the absolute condition “occupied area≤24 m²” using the numerical value (24 m²) obtained by multiplying the numerical value (30 m²) of the main condition by 0.8.

When the calculated absolute condition determination value does not satisfy the absolute condition (No in Step S108), the concretization unit 22 changes the candidate equipment configuration to be processed back to the candidate equipment configuration before application of the concretization pattern in Step S106 (Step S109). Specifically, the candidate equipment configuration to be processed returns to the candidate equipment configuration before application in FIG. 9. Then, the process returns to Step S104.

When, on the other hand, the calculated absolute condition determination value satisfies the absolute condition (Yes in Step S108), the process returns to Step S104. At this point, the candidate equipment configuration to be processed is the candidate equipment configuration after application in FIG. 9.

When the “sub-condition list” is not empty (No in Step S104), the concretization unit 22 selects one sub-condition from the “sub-condition list” (Step S105). It is assumed in this example that “estimated number of clients=600 people/day” is selected as the sub-condition.

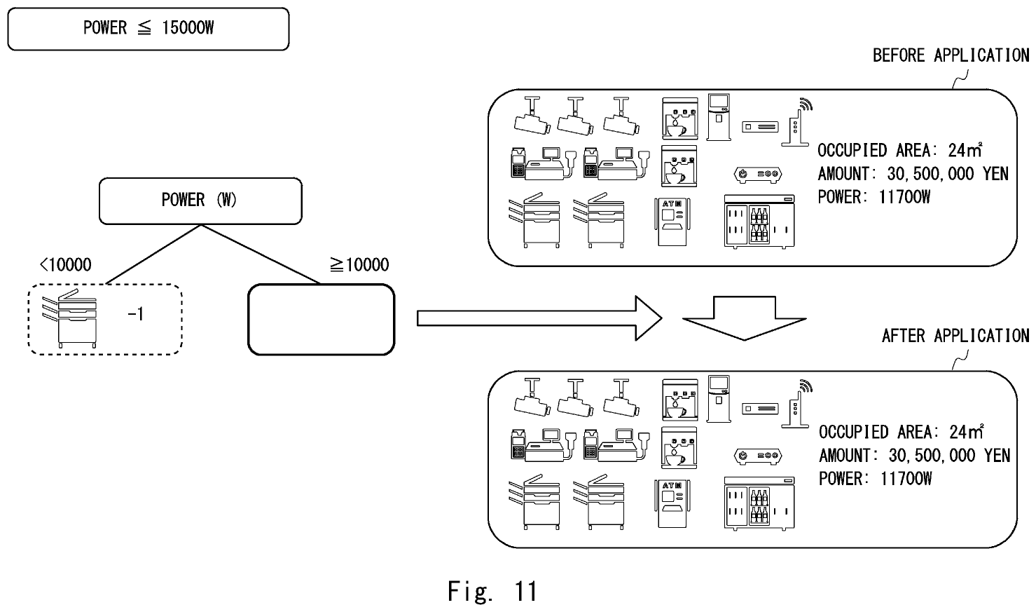

The concretization unit 22 applies the concretization pattern corresponding to the selected sub-condition to the candidate equipment configuration to be processed, and thereby generates a candidate equipment configuration (Step S106). In this example, as shown in FIG. 10, the concretization unit 22 applies the “concretization pattern when the estimated number of clients per day is equal to or more than 600 and less than 1000” to the candidate equipment configuration to be processed. Specifically, in the example of FIG. 10, one surveillance camera is added to the candidate equipment configuration to be processed.

The concretization unit 22 calculates the “absolute condition determination value” for the main condition (main entry) in the candidate equipment configuration generated in Step S106 (Step S107). In this example, as shown in FIG. 10, the calculated “absolute condition determination value” is “24 m²”.

The concretization unit 22 determines whether the calculated absolute condition determination value satisfies the absolute condition (which is “occupied area≤30 m²” in this example) or not (Step S108). In this example, since the calculated absolute condition determination value satisfies the absolute condition, the process returns to Step S104.

When the “sub-condition list” is not empty (No in Step S104), the concretization unit 22 selects one sub-condition from the “sub-condition list” (Step S105). It is assumed in this example that the “power≤15000 W” is selected as the sub-condition. It is assumed that the “sub-condition list” becomes empty as a result of this selection.

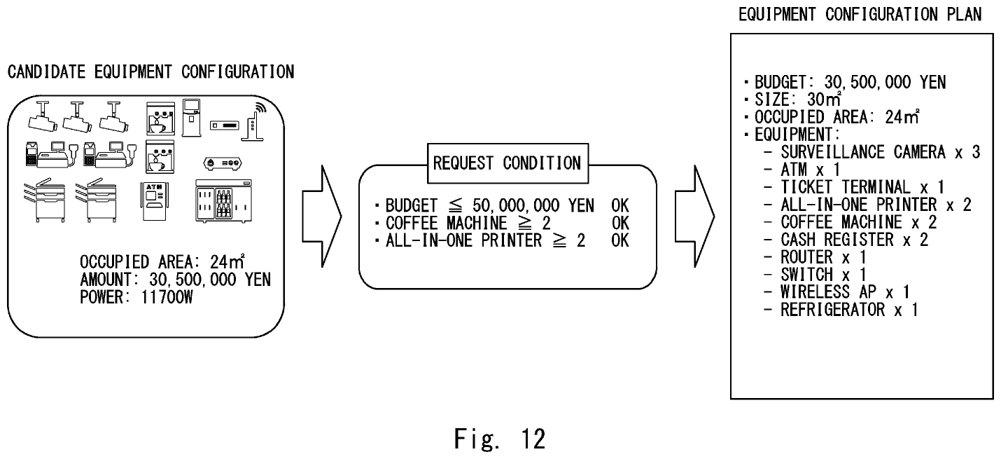

The concretization unit 22 applies the concretization pattern corresponding to the selected sub-condition to the candidate equipment configuration to be processed, and thereby generates a candidate equipment configuration (Step S106). In this example, as shown in FIG. 11, the concretization unit 22 applies the “concretization pattern when power is equal to or more than 10000” to the candidate equipment configuration to be processed. Specifically, in the example of FIG. 11, no device is added to or eliminated from the candidate equipment configuration to be processed.

The concretization unit 22 calculates the “absolute condition determination value” for the main condition (main entry) in the candidate equipment configuration generated in Step S106 (Step S107). In this example, as shown in FIG. 11, the calculated “absolute condition determination value” is “24 m²”.

The concretization unit 22 determines whether the calculated absolute condition determination value satisfies the absolute condition (which is “occupied area≤30 m²” in this example) or not (Step S108). In this example, since the calculated absolute condition determination value satisfies the absolute condition, the process returns to Step S104.

Since the “sub-condition list” is empty as described above, the concretization unit 22 outputs the calculated “request condition determination value”, the candidate equipment configuration to be processed, and the “request condition” to the request verification unit 25. It is assumed in this example that the “request condition” is “budget≤50,000,000 yen”, “two or more coffee machines”, and “two or more all-in-one printers”.

The request verification unit 25 determines whether the candidate equipment configuration satisfies the request or not (Step S110). When the candidate equipment configuration does not satisfy the request (No in Step S110), the request verification unit 25 passes a determination result indicating that the request is not met to the concretization unit 22. Then, the process flow in FIG. 7 ends.

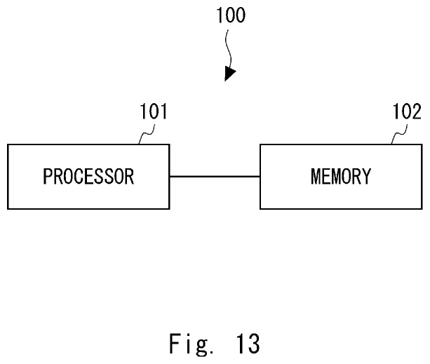

On the other hand, when the candidate equipment configuration satisfies the request (Yes in Step S110), the request verification unit 25 passes a determination result indicating that the request is satisfied to the concretization unit 22. Then, the concretization unit 22 passes the candidate equipment configuration that satisfies the request to the concretization unit 22. The output unit 26 outputs the candidate equipment configuration received from the concretization unit 22 as the equipment configuration plan (Step S111). Specifically, as shown in FIG. 12, the request verification unit 25 determines whether the candidate equipment configuration satisfies the request or not. When the candidate equipment configuration satisfies the request, the output unit 26 outputs the candidate equipment configuration as the equipment configuration plan. FIG. 12 is a view illustrating request verification in the second example embodiment.

As described above, according to the second example embodiment, in the equipment configuration plan generation device 20, the concretization unit 22 concretizes devices to be installed in a store in a step-by-step manner on the basis of the concretization pattern corresponding to the input value of each entry of the constraint condition.

This configuration of the equipment configuration plan generation device 20 enables the step-by-step concretization of devices to be installed in a store.

For example, in the equipment configuration plan generation device 20, the concretization unit 22 generates the candidate base equipment configuration by using the concretization pattern corresponding to the input value (main condition) of the main entry regarding the constraint condition. Then, the concretization unit 22 applies the concretization pattern corresponding to the input value (sub-condition) of the “sub-entry” regarding the constraint condition to the generated candidate base equipment configuration, and thereby generates the candidate equipment configuration.

Since this configuration of the equipment configuration plan generation device 20 allows generating the candidate base equipment configuration, which serves as a base of equipment configuration, at the beginning by using the concretization pattern corresponding to the input value of the main entry, it enables the high-speed generation of the equipment configuration plan.

### MODIFIED EXAMPLE

<1> The concretization unit 22 may calculate a “sub-condition determination value” in addition to calculating the absolute condition determination value. In this case, in Step S108, the concretization unit 22 may determine whether the sub-condition determination value satisfies the sub-condition or not in addition to determining whether the absolute condition determination value satisfies the absolute condition or not. Then, the process may proceed to Step S104 when the absolute condition determination value satisfies the absolute condition and the sub-condition determination value satisfies the sub-condition. For example, the concretization unit 22 may calculate the total power consumption of the devices contained in the “candidate equipment configuration” as the “sub-condition determination value”.

<2> Although a device list is generated as the “equipment configuration plan” in FIG. 12, the example embodiment is not limited thereto. For example, a network configuration may be generated as the “equipment configuration plan” by applying a “concretization pattern that concretizes the connection between devices” to the devices contained in the device list. This “concretization pattern that concretizes the connection between devices” may be also stored in the concretization pattern registration DB 23.

### Other Example Embodiments

FIG. 13 is a view showing a hardware configuration example of an equipment configuration plan generation device. In FIG. 13, an equipment configuration plan generation device 100 includes a processor 101 and a memory 102. The processor 101 may be a microprocessor, an MPU (Micro Processing Unit) or a CPU (Central Processing Unit), for example. The processor 101 may include a plurality of processors. The memory 102 is a combination of a volatile memory and a nonvolatile memory. The memory 102 may include a storage that is placed apart from the processor 101. In this case, the processor 101 may access the memory 102 through an I(Input)/O(Output) interface, which is not shown.

Each of the equipment configuration plan generation devices 10 and 20 according to the first and second example embodiments may have the hardware configuration shown in FIG. 13. The input unit 11, 21, the concretization unit 12, 22, the output unit 13, 26, and the request verification unit 25 of the equipment configuration plan generation device 10, 20 according to the first and second example embodiments may be implemented by reading and executing, by the processor 101, a program stored in the memory 102. The concretization pattern registration database (DB) 23 and the device data registration database (DB) 24 may be implemented by the memory 102. The program may be stored using various types of non-transitory computer readable media and supplied to the equipment configuration plan generation device 10, 20. Examples of non-transitory computer readable media include magnetic storage media (such as flexible disks, magnetic tapes, hard disk drives, etc.), and optical magnetic storage media (e.g. magneto-optical disks). Examples of non-transitory computer readable media further include CD-ROM (Read Only Memory), CD-R, and CD-R/W. Examples of non-transitory computer readable media further include semiconductor memories. The semiconductor memories include mask ROM, PROM (Programmable ROM), EPROM (Erasable PROM), and flash ROM, RAM (Random Access Memory). The program may be provided to the equipment configuration plan generation device 10, 20 using various types of transitory computer readable media. Examples of transitory computer readable media include electric signals, optical signals, and electromagnetic waves. Transitory computer readable media can provide the program to the equipment configuration plan generation device 10, 20 via a wired communication line such as an electric wire or an optical fiber, or a wireless communication line.

The first and second example embodiments can be combined as desirable by one of ordinary skill in the art.

The present disclosure provides an equipment configuration plan generation device, an equipment configuration plan generation method, and a control program that enable generation of a flexible equipment configuration plan that satisfies the requests from a client.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

What is claimed is:

1. An equipment configuration plan generation device comprising:
at least one memory storing instructions, and
at least one processor configured to execute, according to the instructions, a process including:
receiving input values of an entry regarding a request related to facility construction of a store and an entry regarding a constraint condition related to the store;
first concretizing devices to be installed in the store in a step-by-step manner according to an input value of each entry regarding the constraint condition in order to generate an equipment configuration plan containing specific devices and satisfying the request; and
outputting the generated equipment configuration plan.

2. The equipment configuration plan generation device according to claim 1, wherein
the at least one memory stores a plurality of concretization patterns, each concretization pattern corresponding to an entry of the constraint condition, designed to concretize devices to be installed in the store, and
the first concretizing includes second concretizing devices to be installed in the store on the basis of a concretization pattern corresponding to an input value of each entry of the constraint condition.

3. The equipment configuration plan generation device according to claim 2, wherein the second concretizing includes generating a candidate base equipment configuration by using a concretization pattern corresponding to an input value of a main entry regarding the constraint condition, applying a concretization pattern corresponding to an input value of a sub-entry regarding the constraint condition to the generated candidate base equipment configuration in order to generate a candidate equipment configuration.

4. The equipment configuration plan generation device according to claim 3, wherein the process further comprising:
verifying whether the candidate equipment configuration satisfies the request.

5. The equipment configuration plan generation device according to claim 4, wherein the outputting includes outputting the candidate equipment configuration as the equipment configuration plan when the candidate equipment configuration satisfies the request.

6. The equipment configuration plan generation device according to claim 1, wherein
the entry regarding the request includes at least one of a budget and a device desired to be installed, and
the entry regarding the constraint condition includes at least one of a location and a size of the store.

7. An equipment configuration plan generation method comprising:
receiving input values of an entry regarding a request related to facility construction of a store and an entry regarding a constraint condition related to the store; and
concretizing devices to be installed in the store in a step-by-step manner according to an input value of each entry regarding the constraint condition, and thereby generating an equipment configuration plan containing specific devices and satisfying the request.

8. A non-transitory computer readable medium storing a control program causing an equipment configuration plan generation device to execute a process of:
receiving input values of an entry regarding a request related to facility construction of a store and an entry regarding a constraint condition related to the store; and
concretizing devices to be installed in the store in a step-by-step manner according to an input value of each entry regarding the constraint condition, and thereby generating an equipment configuration plan containing specific devices and satisfying the request.
